(19) United States
(12) Patent Application Publication
(10) Pub. No.: US 2026/0142958 A1
(43) Pub. Date: May 21, 2026

(54) DIGITAL CONTENT ACCESS AUTHENTICATION USING A CRYPTOGRAPHIC POSSESSION FACTOR

(71) Applicant: eBay Inc., San Jose, CA (US)

(72) Inventors: Swanand Abhyankar, Milpitas, CA (US); Harshada Sunil Adhikari, Newark, CA (US); Rahul Derashri, San Jose, CA (US); Sandeep Kumar, Fremont, CA (US); Prabhakara Rao Vadlaputi, San Ramon, CA (US)

(73) Assignee: eBay Inc., San Jose, CA (US)

(21) Appl. No.: 18/954,777

(22) Filed: Nov. 21, 2024

(51) Int. Cl. H04L 9/40

(52) U.S. Cl. CPC H04L 63/0807; H04L 63/101; H04L 63/105

(57) ABSTRACT

Digital content authentication using a cryptographic possession factor is described. In one or more examples, a navigation request to access a webpage is received and verified, over a plurality of iterations over a session, that an originator of the navigation request maintains a cryptographic token as bound within a browser through use of a public key associated with the cryptographic token. A log describing the verifying is stored and then a determination is made that the webpage involves additional authentication usable to extend the session to access the webpage. A level of the authentication is selected for access to the webpage based on the cryptographic token maintained at the browser and the log. Access to the webpage is controlled based on the selected level of authentication.

### BACKGROUND

Conventional cybersecurity techniques struggle to strike a balance between strong security and user convenience in digital content access, e.g., particularly on webpages involving confidential information. Conventional multi-factor authentication (MFA) measures, for instance, grant user access based on the successful receipt of at least two identifying factors. However, conventional MFA measures fall short in ongoing session validation and longevity.

Conventional MFA techniques, for instance, employed in typical real-world scenarios involve active user participation in order to pass security checks throughout a secure session. This user participation is disruptive to the user experience and often results in user friction that has an adverse effect on a user's willingness to continue to request access to the digital content.

### SUMMARY

Digital content authentication techniques using a cryptographic possession factor are described. This possession factor takes the form of a cryptographic token that is uniquely tied to a user, e.g., a computing device associated with the user. The user and the user device are authenticated using an asymmetric cryptographic public-private key pair.

In one or more examples, registration occurs in which the token is used to (i) authenticate a user's device for digital content access, and (ii) bind the user device to a cryptographic public-private key pair. This binding is recorded in a storage device such that a persistent cryptographic association is created.

Based on the cryptographic association, an extension of a session is supported. The extension, for instance, is configurable to support continuous silent authentication of the user device and thereby allows continued access to the digital content, e.g., a secure webpage as well as to additional secure webpages.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to authenticate, using cryptographic possession factor techniques, a computing device requesting access to one or more webpages provided by a service provider system.

FIG. 2 depicts a system that includes the service provider system and the computing device of FIG. 1, whereby a cryptographic token identifying the computing device is generated and provided to the service provider system.

FIG. 3 depicts a system that includes the service provider system and the computing device of FIG. 1, whereby using the cryptographic token the service provider system registers the computing device and binds the computing device to a public-private key pair.

FIG. 4 is a flow diagram depicting a step-by-step procedure of receiving a cryptographic token, registering the computing device, and binding the computing device at the service provider system.

FIG. 5 depicts a system that includes the service provider system and the computing device of FIG. 1, whereby the computing device is continuously and silently authenticated to receive a current webpage or additional webpages from the service provider system, based on the receipt by the service provider system of the cryptographic token at regular intervals.

FIG. 6 is a flow diagram depicting a step-by-step procedure of performing continuous and silent authentication of the computing device by the service provider system.

FIG. 7 illustrates an example system including various components of an example device that can be implemented as any type of computing device as described and/or utilized with reference to FIGS. 1-6 to implement embodiments of the techniques described herein.

### DETAILED DESCRIPTION

### Overview

Digital content such as webpages are under continual attack by malicious parties in order to gain access to confidential information. To protect this confidential information, security measures have tightened through the introduction of multi-factor authentication (MFA). MFA involves the use of at least two pieces of authenticating evidence in order to control access to secure data. These pieces of evidence are known as “factors” and can take several forms: (i) a knowledge factor, which is something a user knows, such as a PIN or password and (ii) an inherent factor, which would include face recognition or voice recognition. A variety of other factors may also be used as pieces of evidence to control digital content access.

Technical challenges have arisen, however, due to the increases in online security, e.g., due to continual security prompts to access secure data over the Internet. For example, a password and login ID might be supplied to access a website generally, followed by an additional code prompt to, for example, change a password. Additionally, a lapse of time without interaction may cause output of a further prompt.

Accordingly, to address these and other technical challenges a cryptographic possession factor is described for use in controlling digital content authentication. The cryptographic possession factor, for instance, is configurable for storage on a computing device as a way to decrease frequency of security prompts. The possession factor, in one or more examples, is configurable as a software token that is usable to assure a provider of secure materials that a requestor is legitimate.

In one or more examples, a cryptographic public/private key pair is used to create a cryptographic token that is stored on the consumer's device for user authentication, e.g., referred to as a “stored cryptographic token.” The public key is available to be disclosed publicly. The private key is available solely to the computing device.

The cryptographic token supports a variety of functionality. In a first example, the cryptographic token is used to initially perform user authentication. The cryptographic token is also usable in a second example for user authentication in a continuous and ongoing manner, i.e., in support of “continuous and silent” authentication, e.g., through comparison with a stored cryptographic token.

In a scenario involving registration, for instance, a service provider system transmits a script for execution by a browser as functionality that is executable by a platform for data presentation over a network, e.g., responsive to navigation to a webpage. The browser executes the script to create the public/private keys. The service provider system further transmits to the browser a timestamp as a message digest along with a nonce in this example.

The browser uses the private key to create a digital signature. The browser then generates and stores a token, which includes the digital signature, the message digest, the nonce, and the public key.

The browser embeds the token in a cookie and transmits the cookie (with the token embedded therein) to the service provider system. Upon receipt of the token, the service provider system uses the public key to perform user authentication. The service provider system is also configurable to confirm the token is timely (e.g., “not too old”) using the timestamp message digest.

The service provider system also binds the computing device to the private/public key pair stored in the browser. That is to say, each webpage request arriving from the consumer device is to include the digital signature created by the stored private key. If there is an irregularity in this regard, the service provider system is configurable to detect this irregularity as a failure in security, i.e., as a potential security threat.

In registering the token, the service provider system stores the user's identification, device identification, and the public key. The registration is usable to initially authenticate and reauthenticate a user, e.g., for future requests to access webpages.

Once a computing device is verified for digital content access, the computing device may then be reauthenticated without further user interaction. Conditions that may prompt reauthentication include access to other webpages having security functionality and continued access to a webpage, for which the computing device is already authenticated, to continue this access.

Once registered, the computing device is configurable to continue token generation (e.g., at a regular interval such as twenty seconds), embed the token in a cookie, and transmit the cookie with the token embedded therein to the server. Tokens provided subsequent to the initial token may be configured independently of the public key, as the public key is already stored at the service provider system. These subsequent tokens, for instance, may include solely the digital signature, message digest, and nonce.

Upon receipt of the subsequent tokens, the service provider system uses the stored public key to reauthenticate the computing device, e.g., using the digital signature. As a result, authentication and reauthentication are performable without additional user input, e.g., to answer any further security questions or otherwise engage with the service provider system. Further discussion of these and other examples is included in the following sections and shown in corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Cryptographic Possession Factor Environment

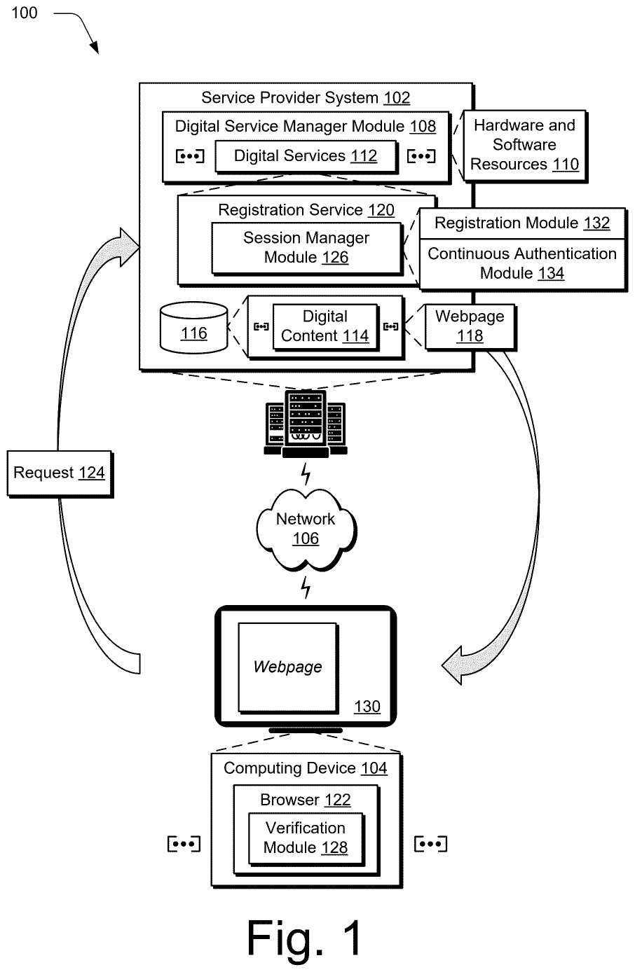

FIG. 1 is an illustration of an environment 100 in an example implementation that is operable to perform digital content authentication using a cryptographic possession factor.

The illustrated environment 100 includes a service provider system 102, implemented using one or more servers as illustrated. The environment 100 also includes a computing device 104, functioning as a remote device as associated with a user. The service provider system 102 and the computing device are communicatively coupled, one to another, via a network 106. Computing devices are configurable in a variety of ways.

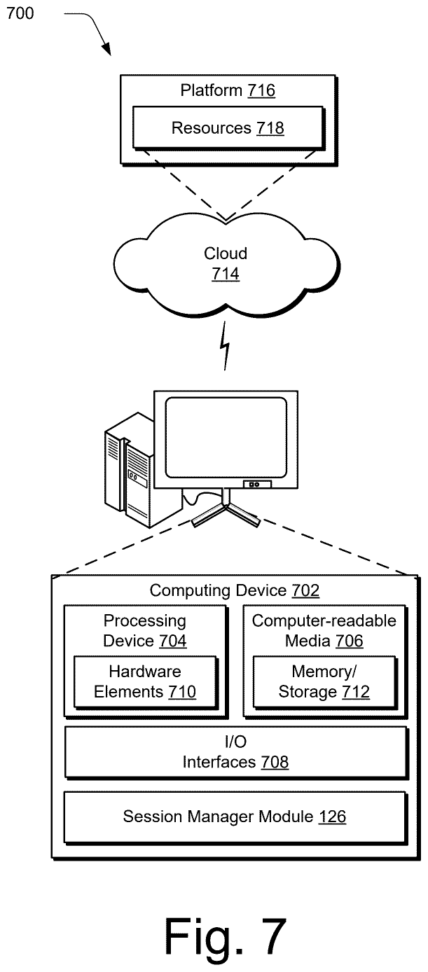

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 7.

The service provider system 102 includes a digital service manager module 108 that is implemented using hardware and software resources 110 (e.g., a processing device and computer-readable storage medium) in support of one or more digital services 112. Digital services 112 are made available, remotely, via the network 106 to computing devices, e.g., the computing device 104.

Digital services 112 are scalable through implementation by the hardware and software resources 110 and support a variety of functionalities, including accessibility, verification, real-time processing, analytics, load balancing, and so forth. Examples of digital services providing digital content 114 include social media service, streaming service, digital content repository service, content collaboration service, and so on. The digital content 114 further specifically includes webpages 118 that may be coded in a variety of different formats and markup languages as is known in the art (XML, HTML, SGML, LaTeX, etc.). The digital content 114, including webpages 118, are stored in a database 116 as is known in the art. Other types of digital content 114 are also contemplated, e.g., user interfaces of a mobile application.

Accordingly, in the illustrated example, the computing device 104 accesses the one or more digital services 112 and digital content 114, including the webpages 118, via the network 106. The webpages 118 received by the computing device 104 are processed by the computing device 104 using a browser 122, e.g., as presented for display in a user interface 130.

Webpages 118 are configurable to employ a variety of security techniques to control access by the computing device 104 and may include secure webpages that cannot be provided to the computing device 104 without authentication of the computing device 104 as being authorized to receive the webpages 118. Requests 124 (also referred to as “navigation requests”) to access secure webpages 118 are provided by the computing device 104 to the service provider system 102, and the requests 124 initiate the cryptographic possession factor techniques discussed herein.

The registration service 120 is responsible for processing the requests 124 received from the computing device 104 to access webpages 118. The registration service 120 uses cryptographic techniques to authenticate the computing device 104 for receiving webpages 118 in an ongoing basis in a continuous and silent manner that does not involve active user participation.

The registration service 120 authenticates the computing device 104 in an ongoing basis in what can be described as a session. In networking, a session is a semi-permanent interactive information interchange between two or more communicating devices. The session manager module 126 oversees the session between the service provider system 102 and the computing device 104 where the service provider system 102 authenticates the computing device 104 and provides the computing device 104 with one or more webpages 118.

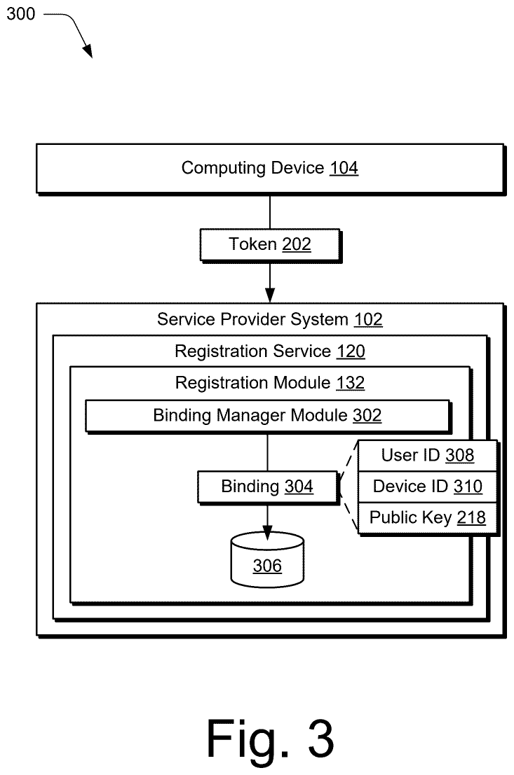

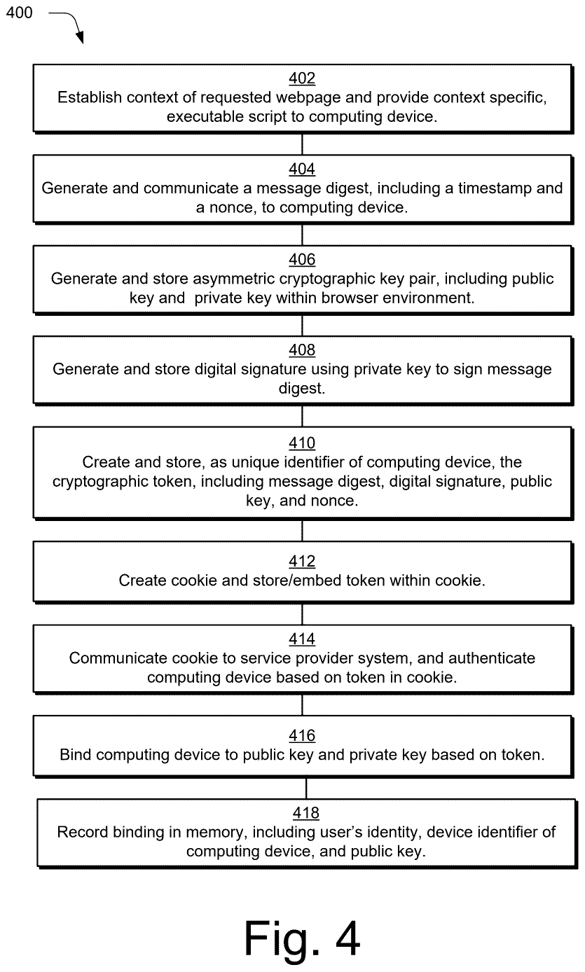

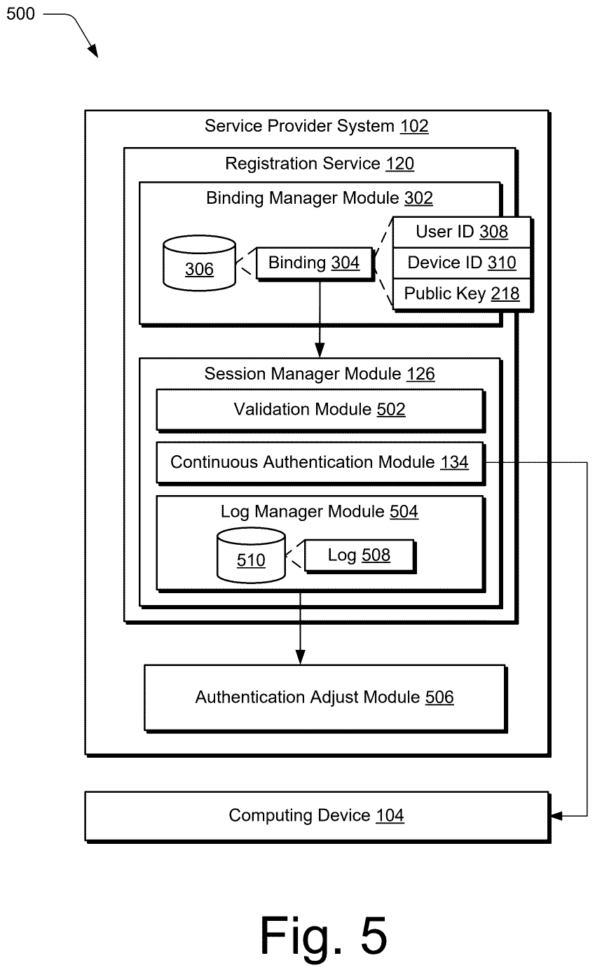

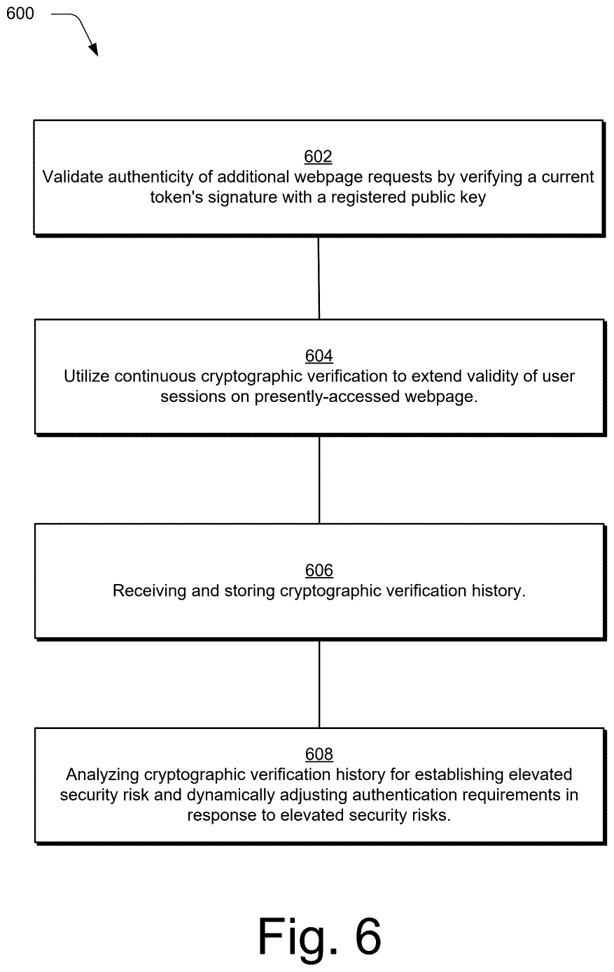

The session manager module 126 includes a registration module 132 and a continuous authentication module 134. The registration module 132 manages an initial authentication of the computing device 104 using cryptographic techniques and is described in greater detail further below with reference to FIGS. 3 and 4. The continuous authentication module 134 manages ongoing authentication of the computing device 104, using cryptographic techniques, for continuous access to a webpage 118 or access to additional webpages 118. Functionality of the continuous authentication module 134 is described in more detail further below with reference to FIGS. 5 and 6.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Cryptographic Registration

The following discussion describes cryptographic registration techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

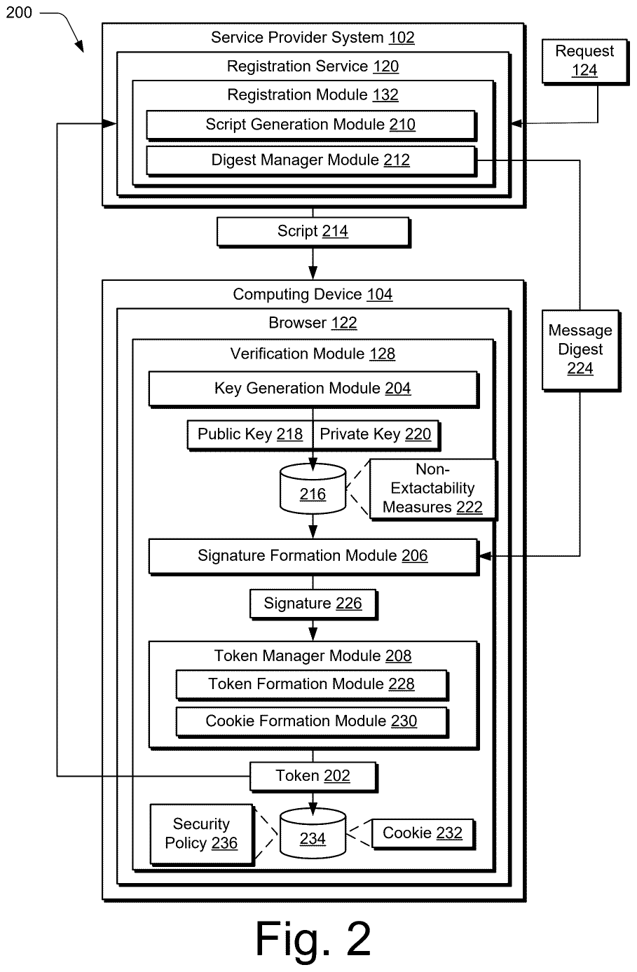

FIG. 2 depicts a system 200 in an example environment 100, the system 200 including the service provider system 102 and the computing device 104 of FIG. 1, in which a cryptographic token 202 identifying the computing device 104 is generated and provided to the service provider system 102.

Computing device 104 includes the verification module 128 that provides verification information to the service provider system 102 to verify and authenticate that the computing device 104 is authorized to access a webpage 118. The verification module 128 includes a key generation module 204, a signature formation module 206, and a token manager module 208, as described in further detail below.

Operation of the registration module 132 is first discussed. The registration module 132 includes a script generation module 210 and a digest manager module 212.

As indicated briefly above, access to a webpage 118 is initiated through a request 124 made by the computing device 104 of the service provider system 102. The request 124 in this example is routed to the registration service 120.

Upon receipt of the request 124 by the registration service 120, the script generation module 210 operates to provide a script 214 to the computing device 104. As is known in the art, the script 214 is a sequence of executable instructions, which may or may not be compiled in advance of execution by a processing device.

The script generation module 210 operates to establish the context of the webpage 118 and provides, over the network 106, the script 214 as a context-specific executable script. Upon receipt of the script 214, the browser 122 executes the script 214 in a non-blocking manner.

The script 214, when executed by the browser 122, first causes the key generation module 204 of the computing device 104 to determine whether there are pre-existing cryptographic keys in the browser's (indexed) database 216. Public/private key encryption uses the two related keys to protect data. The public key may be made available while the private key is maintained privately, e.g., by the computing device 104). The two cryptographic keys work together to guard access to encrypted data.

If the key generation module 204 determines an absence of pre-existing cryptographic keys in the database 216, the key generation module 204 generates an asymmetric cryptographic key pair, including the public key 218 and the private key 220, within the browser 122 environment. The public key 218 and private key 220 are stored in the database 216.

It should be noted that the security of the private key 220 within the database 216 is ensured by implementation of non-extractability measures 222 within the browser 122. The non-extractability measures 222 adhere to robust cryptographic standards.

Approximately simultaneous or shortly after the provision of the script 214 to the computing device 104, the digest manager module 212 is configurable to generate a message digest 224. The message digest 224 is configurable as a hash usable to protect data integrity by enabling detection of changes and alterations to a message.

In this particular instance, the message digest 224 includes a timestamp to ensure temporal relevance. The message digest 224 also includes a nonce (a single use item, often an arbitrary number, to ensure uniqueness in communication sessions) that acts as a further security layer, designed to protect against replay attacks.

The digest manager module 212 provides the message digest 224 to the computing device 104, and in particular, the signature formation module 206 of the computing device 104. The signature formation module 206 creates a digital signature 226 by employing the private key 220 to sign the message digest 224, thereby authenticating the data's origin and integrity.

Processing next occurs in the token manager module 208, which receives the digital signature 226. The token manager module 208 includes a token formation module 228 and a cookie formation module 230.

The token formation module 228 in particular creates a secure, time-sensitive token 202 as a unique identifier of the computing device 104. The token 202 encapsulates the message digest 224, the digital signature 226, the public key 218, and the nonce that was included with the message digest 224, provided by digest manager module 212 to the signature formation module 206. The token 202 may be viewed as a time-based, one-time password (TOTP) token. Such a token is a single-use token valid for a limited duration.

The cookie formation module 230 creates a cookie 232. The token formation module 228 stores and/or embeds the generated token 202 within the secure cookie 232. The cookie 232, with the token 202 embedded therein, is stored in a storage device 234 associated with the browser 122, e.g., similar to the indexed database 216 or may be an additional database.

Script integrity may be enforced through a content security policy 236. The policy 236 protects the indexed database 216 through a same origin policy, which restricts how documents and scripts of one origin are able to interact with resources of another origin.

The cryptographic token 202 as embedded in the cookie 232, is communicated to the service provider system 102, and in particular, the registration module 132. The registration module 132 authenticates the computing device 104 based on the token 202, using the public key 218 to obtain the digital signature 226. The registration process further uses the token 202, as depicted in greater detail in FIG. 3.

Specifically, FIG. 3 depicts a system 300, in the environment 100, including the service provider system 102 and the computing device 104. Using the cryptographic token 202, the service provider system 102 registers the computing device 104 and binds the computing device 104 to the public-private key pair stored in the browser 122 as now described. Binding the computing device 104 to the public-private key pair may be viewed as selecting a level of authentication for access to the webpage 118 based on the cryptographic token 202 that is stored and maintained at the browser 122.

As noted above, the cryptographic token 202 is communicated by the computing device 104 to the service provider system 102, and in particular, to the registration module 132. The registration module 132 further includes a binding manager module 302.

When the token 202 is received by the registration module 132, the binding manager module 302 cryptographically binds the computing device 104 to the cryptographic key pair including the public key 218 and the private key 220 stored in the browser 122. The binding manager module 302 records the binding 304 in a storage device 306, the binding 304 including the user's identity 308, the device identifier 310 of the computing device 104, and the public key 218.

The binding 304 establishes a persistent cryptographic association of the computing device 104 to the public key 218 and the private key 220. When the binding 304 is stored, the registration process is complete.

FIG. 4 is a flow diagram depicting an algorithm 400 as a step-by-step procedure in an example implementation of operations performable for accomplishing a result of receiving a cryptographic token 202, registering the computing device 104, and binding the computing device 104 at the service provider system 102.

In particular, step 402 includes establishing by the service provider system 102 a context of a requested webpage and providing a context specific, executable script to the computing device 104. Step 404 includes generating and communicating by the service provider system 102 a message digest 224, including a timestamp and a nonce, to the computing device 104.

Step 406 includes generating and storing within the browser 122 environment in the computing device 104 an asymmetric cryptographic key pair, including the public key 218 and the private key 220. Step 408 includes generating by the computing device 104 the digital signature 226 using the private key 220 to sign the message digest 224.

Step 410 includes creating and storing in the computing device 104, as a unique identifier of the computing device 104, the cryptographic token 202, including the message digest 224, digital signature 226, public key 218, and nonce. Step 412 includes creating the cookie 232 and storing/embedding the token 202 within the cookie 232.

Step 414 includes communicating the cookie 232 to the service provider system 102, and authenticating by the service provider system 102, the computing device 104 based on the token 202 embedded in the cookie 232. Step 416 includes binding by the service provider system 102 the computing device 104 to the public key 218 and the private key 220, based on the token 202. Step 418 includes recording the binding 304, including the user's identity 308, the device identifier 310 of the computing device 104, and the public key 218, in the storage device 306.

### Continuous Assurance and Continuous/Silent Authentication

FIG. 5 depicts a system 500, in an environment 100 of FIG. 1, that includes the service provider system 102 and the computing device 104. The computing device 104 is continuously and silently authenticated to receive a webpage 118 (e.g., or additional webpages) from the service provider system 102, based on the receipt by the service provider system 102 of the cryptographic token 202 at defined intervals. Operation of the registration service 120 of FIG. 1 is shown in greater detail in FIG. 5.

The functioning of the session manager module 126 of the registration service 120 is now discussed. The session manager module 126 includes the validation module 502, the continuous authentication module 134, and the log manager module 504. The session manager module 126 functions to enable access to a webpage 118 using the binding 304, e.g., for silent authentication of the computing device 104.

In particular, the session manager module 126 receives from the binding manager module 302, the stored binding 304 that establishes a persistent cryptographic association of the computing device 104 to the public key 218 and the private key 220. The binding 304 and the persistent cryptographic association represent a selected level of authentication for access to the webpage 118 and control access to the webpage 118. Access to additional webpages 118 involving authentication at a similar level as the selected level are also controlled based on the binding 304.

The validation module 502 uses the binding 304 to validate and verify the authenticity of requests 124 by obtaining the digital signature 226 of a regenerated token 202 and using the registered public key 218 stored in the binding 304. This validation and verification function may occur over multiple iterations of requests 24 in a session and may be called continuous assurance because the user of the computing device 104, as the originator of an original request 124, is assured of access to the original webpage 118 and additional webpages so long as the regenerated token 202 remains valid, i.e., the digital signature 226 can be validated and verified from the public key 218.

It should be noted that regenerated tokens are configurable as slightly different from the token 202 stored in the binding 304, as the regenerated tokens do not include the public key 218 as previously described. However, reference is made to both the initial token 202, as stored in the binding 304, and regenerated tokens simply as “token” or “cryptographic token,” without distinction.

It should be further noted that regenerated tokens are each embedded in an overwriting cookie, each including the message digest 224, digital signature 226, and nonce. The overwriting cookie overwrites a previously stored cookie 232 stored in the storage device 234 and received at the registration service 120 of the service provider system 102.

The continuous authentication module 134 additionally utilizes continuous cryptographic verification, i.e., additional silent authentication, to extend the validity of user sessions on webpages 118, thereby enhancing security without compromising user experience. More specifically, a user may continuously access a single webpage 118, without further prompts based on the computing device 104 providing tokens 202 at a regular interval.

A session is thus extended over the plurality of iterations of requests 124 based on receipt of the token 202, embedded in the cookie 232, at regular intervals by the registration service 120 of the host of the webpages 118. This functionality of the continuous authentication module 134 may be referred to as continuous and silent authentication because the user may be unaware that an associated computing device 104 is being re-authenticated.

The log manager module 504 stores a log 508 in a memory, e.g., a storage device 510. As indicated above, once the token 202 is initially received and the computing device 104 is bound to the public key 218-private key 220 pair, the validation module 502 and the continuous authentication module 134 conduct cryptographic verification for each request 124 for the current and additional webpages 118. The results of these verifications are received by the log manager module 504 as a cryptographic verification history that is stored as the log 508.

The results of the ongoing cryptographic verification are also provided to the authentication adjust module 506. This module analyzes the results of the cryptographic verification history log for accountability and traceability. If there is a sufficient indication, based on predetermined criteria, that there is an enhanced security risk, the authentication adjust module 506 dynamically adjusts authentication criteria in response to assessed risk levels.

If the token 202 is not received at a regular interval, e.g., at intervals of differing lengths, by the registration service 120, the validation module 502 or the continuous authentication module 134 ceases access to a webpage 118. Also, if an irregular token 202, e.g., a token with an incorrect digital signature 226, is received by the registration service 120, the validation module 502 or the continuous authentication module 134 ceases access to a webpage 118.

Discontinuing access to a webpage 118 includes “unverifying” (i.e., removing an indication of a previously performed verification) that the originator of a request 124 maintains the token 202 as bound within the browser 122. That is to say, discontinuing access to a webpage 118 is failing authentication of the computing device 104. In the case where access to a webpage 118 is discontinued, or where there is an indication of an enhanced security risk, a new level of authentication is selectable having increased protection over a previously selected level of authentication, as controlled by the binding 304.

FIG. 6 is a flow diagram depicting an algorithm 600 as a step-by-step procedure in an example implementation of operations performable for accomplishing a result of (i) validating the authenticity of the computing device 104 for access to additional webpages 118; (ii) conducting continuous cryptographic verification of the computing device 104 to extend user sessions on currently-accessed webpages 118; (iii) receiving a cryptographic verification history; and (iv) analyzing the cryptographic verification history for dynamically adjusting authentication requirements in response to elevated risks.

For example, step 602 includes validating the authenticity of additional webpage requests by verifying a current token's signature with a registered public key. Validating, for instance, is performed regarding the authenticity of requests for access to additional webpages 118 that are received from the computing device 104 by comparing the digital signature 226 of the present regenerated token 202 with the registered public key 218 stored in the binding 304. Continuous assurance is provided upon a resulting validation.

Step 604 includes utilizing continuous cryptographic verification of the computing device 104 to extend validity of user sessions on presently accessed webpages 118. Upon verification, silent and continuous access to the webpages 118 is provided without involving active participation on the part of the user of the computing device 104.

Step 606 includes receiving from the validation module 502 and the continuous authentication module 134 a cryptographic verification history. Step 606 also includes storing of the cryptographic verification history.

Step 608 includes analyzing, by the authentication adjust module 506 of the service provider system 102, the cryptographic verification history for establishing whether there is an elevated security risk. Step 608 further includes dynamically adjusting authentication criteria in response to the elevated security risks.

### Example System and Device

FIG. 7 illustrates an example system generally at 700 that includes an example computing device 702 that is representative of one or more computing systems and/or devices that implement the various techniques described herein. This is illustrated through inclusion of the session manager module 126 of FIG. 1. The computing device 702 is configurable, for example, as a server of a service provider, a device associated with a client (e.g., a client device), an on-chip system, and/or any other suitable computing device or computing system.

The example computing device 702 as illustrated includes a processing device 704, one or more computer-readable media 706, and one or more I/O interface 708 that are communicatively coupled, one to another. Although not shown, the computing device 702 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 704 is representative of functionality to perform one or more operations using hardware. Accordingly, the processing device 704 is illustrated as including hardware elements 710 that are configurable as processors, functional blocks, and so forth. This includes implementation in hardware as an application specific integrated circuit or other logic device formed using one or more semiconductors. The hardware elements 710 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 706 is illustrated as including memory/storage 712 that stores instructions that are executable to cause the processing device 704 to perform operations. The computer-readable storage medium is configured for storing instructions that, responsive to execution by the processing device 704, causes the processing device 704 to perform operations. The memory/storage 712 represents memory/storage capacity associated with one or more computer-readable media. The memory/storage 712 includes volatile media (such as random access memory (RAM)) and/or nonvolatile media (such as read only memory (ROM), Flash memory, optical disks, magnetic disks, and so forth). The memory/storage 712 includes fixed media (e.g., RAM, ROM, a fixed hard drive, and so on) as well as removable media (e.g., Flash memory, a removable hard drive, an optical disc, and so forth). The computer-readable media 706 is configurable in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 702. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 702, such as via a network. Signal media typically embodies computer readable instructions, data structures, program modules, or other data in a modulated data signal, such as carrier waves, data signals, or other transport mechanism. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also being employed to implement various techniques described herein. Accordingly, software, hardware, or executable modules are implemented as one or more instructions and/or logic embodied on some form of computer-readable storage media and/or by one or more hardware elements 710. The computing device 702 is configured to implement particular instructions and/or functions corresponding to the software and/or hardware modules. Accordingly, implementation of a module that is executable by the computing device 702 as software is achieved at least partially in hardware, e.g., through use of computer-readable storage media and/or hardware elements 710 of the processing device 704. The instructions and/or functions are executable/operable by one or more articles of manufacture (for example, one or more computing devices 702 and/or processing devices 704) to implement techniques, modules, and examples described herein.

The techniques described herein are supported by various configurations of the computing device 702 and are not limited to the specific examples of the techniques described herein. This functionality is also implementable all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 include applications and/or data that can be utilized while computer processing is executed on servers that are remote from the computing device 702. Resources 718 can also include services provided over the Internet and/or through a subscriber network, such as a cellular or Wi-Fi network.

The platform 716 abstracts resources and functions to connect the computing device 702 with other computing devices. The platform 716 also serves to abstract scaling of resources to provide a corresponding level of scale to encountered demand for the resources 718 that are implemented via the platform 716. Accordingly, in an interconnected device embodiment, implementation of functionality described herein is distributable throughout the system 700. For example, the functionality is implementable in part on the computing device 702 as well as via the platform 716 that abstracts the functionality of the cloud 714.

In implementations, the platform 716 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A method comprising:
receiving a navigation request to access a webpage;
verifying over a plurality of iterations within a session that an originator of the request maintains a cryptographic token as bound within a browser through use of a public key associated with the cryptographic token;
storing a log describing the verifying;
determining the webpage involves additional authentication usable to extend the session to access the webpage;
selecting a level of the authentication for access to the webpage based on the cryptographic token maintained at the browser and the log; and
controlling access to the webpage based on the selected level of authentication.

2. The method according to claim 1, further comprising:
storing a record of the cryptographic token as a stored cryptographic token; and
controlling access to an additional webpage of a similar authentication level as that of the selected level of authentication based on a comparison of the stored cryptographic token to the cryptographic token as bound within the browser.

3. The method according to claim 1, wherein the session is extended to access the webpage when the verifying over the plurality of iterations includes receipt of the cryptographic token at a regular interval by a host of the webpage.

4. The method according to claim 3, wherein the cryptographic token is received at the regular interval embedded in a cookie.

5. The method according to claim 3, further comprising removing an indication the originator of the request maintains the cryptographic token as bound within the browser responsive to determining the cryptographic token is not received at the regular interval or an irregular token is received by the host of the webpage.

6. The method according to claim 5, wherein the controlling access to the webpage is changed to be based on a new level of authentication that has increased protections than the selected level of authentication.

7. The method according to claim 1, wherein the cryptographic token includes a digital signature generated from a private key of a key pair including the public key.

8. A computing device comprising:
a processing device; and
a non-transitory computer-readable storage medium storing instructions that, responsive to execution by the processing device, cause the processing device to perform operations including:
providing a script for receipt by a remote device;
communicating a message digest for receipt by the remote device, the message digest configurable to cause the remote device to generate and store a cryptographic key pair, including a private key and a public key;
creating a binding establishing a persistent cryptographic association of the remote device to the cryptographic key pair based on a cookie received from the remote device, the cookie generated based on a token that includes the message digest, a digital signature, and the public key; and
authenticating access of the remote device based on the binding.

9. The computing device according to claim 8, wherein the message digest is a timestamp.

10. The computing device according to claim 9, wherein the token is a time-based one-time password (TOTP) token.

11. The computing device according to claim 10, wherein the message digest includes a nonce, and the token includes the nonce.

12. The computing device according to claim 11, wherein further instructions stored by the computer-readable storage medium, responsive to execution by the processing device, cause the processing device to perform further operations including:
communicating a subsequent message digest for receipt by the remote device;
reauthenticating the remote device based on a subsequent overwriting cookie received from the remote device, the subsequent overwriting cookie generated based on a subsequent token that includes message digest, the digital signature, and the nonce.

13. The computing device according to claim 12, wherein further instructions stored by the computer-readable storage medium, responsive to execution by the processing device, cause the processing device to perform a further operation including failing reauthentication of the remote device when the digital signature or the subsequent message digest in the subsequent token is irregular.

14. The computing device according to claim 13, wherein further instructions stored by the computer-readable storage medium, responsive to execution by the processing device, cause the processing device to perform further operations including:
logging authentication data regarding reauthentication based on the subsequent token and any reauthentication failure; and
adjusting authentication requirements of the remote device when the authentication data indicates, based on predetermined criteria, a potential security threat.

15. A non-transitory computer-readable storage medium having instructions stored thereon, that responsive to execution by a processor of a computing device, the computing device storing a cryptographic token, received from a remote device and binding the remote device to a cryptographic key pair, cause the processor to perform operations including:
authenticating the remote device to have initial access to a secure webpage based on receipt of the cryptographic token;
authenticating the remote device to have continuous access to the secure webpage, based on receipt of the cryptographic token from the remote device at a regular interval; and
authenticating the remote device to have further access to at least one additional secure webpage based on receipt of the cryptographic token.

16. The non-transitory computer-readable storage medium according to claim 15, wherein the authenticating the remote device to have initial access, the authenticating the remote device to have continuous access, and the authenticating the remote device to have further access are performed by the processor without requiring receipt of data input by a user of the remote device.

17. The non-transitory computer-readable storage medium according to claim 15, wherein each receipt of the cryptographic token occurs with the cryptographic token embedded in a cookie.

18. The non-transitory computer-readable storage medium according to claim 15, wherein the cryptographic token includes a public key from the cryptographic key pair.

19. The non-transitory computer-readable storage medium according to claim 18, wherein the cryptographic token includes a digital signature generated from a private key of the key pair.

20. The non-transitory computer-readable storage medium according to claim 19, wherein the cryptographic token includes a nonce.
